(19) United States
(12) Patent Application Publication
(10) Pub. No.: US 2025/0182465 A1
(43) Pub. Date: Jun. 5, 2025

(54) DISPLAY ASSISTANCE APPARATUS, DISPLAY ASSISTANCE METHOD, AND NON-TRANSITORY COMPUTER-READABLE MEDIUM

(71) Applicant: NEC Corporation, Minato-ku, Tokyo (JP)

(72) Inventor: Natsuki YUI, Tokyo (JP)

(73) Assignee: NEC Corporation, Minato-ku, Tokyo (JP)

(21) Appl. No.: 18/842,957

(22) PCT Filed: Mar. 17, 2022
(86) PCT No.: PCT/JP2022/012351

§ 371 Date: Aug. 30, 2024

(51) Int. Cl. G06V 10/94; G06T 7/70; G06V 10/26; G06V 10/764; G06V 10/776

(52) U.S. Cl. CPC G06V 10/945; G06T 7/70; G06V 10/26; G06V 10/764; G06V 10/776; G06T 2207/20104; G06T 2207/20132; G06V 2201/07

(57) ABSTRACT

A display assistance apparatus includes: a detection result acquisition unit that acquires a result of detecting an image including a plurality of detection targets, and in which detection processing is performed; a display processing unit; and an instruction acquisition unit that acquires information indicating an instruction to the result, wherein the display processing unit sets a predetermined number of the detection targets, as a detection result display target, and causes to display position information indicating a position of the detection target within the image, and a certainty score in association with the image, and, when the instruction acquisition unit acquires an instruction to switch the detection target serving as the result display target, the display processing unit switches the detection result display target to another one within the image, and causes to display the position information and the score related to the detection target after the switching.

### TECHNICAL FIELD

The present invention relates to a display assistance apparatus, a display assistance method, and a storage medium.

### BACKGROUND ART

Patent Document 1 describes one example of a system for detecting an object by an image analysis using a machine learning model. The system in Patent Document 1 includes an image capturing apparatus that acquires an image within a target area, an image processing unit that stores a program for detecting an object within the image acquired by the image capturing apparatus with use of deep learning, and a boundary determination unit that determines a positional relationship between a transparent portion capable of visually recognizing an outside from an inside of the target area, and a surrounding object, wherein the system is configured in such a way that mask processing is applied to an area occupied by the transparent portion with respect to the image acquired by the image capturing apparatus, and an object is detected by a program using deep learning, based on the image subjected to the mask processing.

A detection result by deep learning indicates a position of an object by surrounding the object detected in a target image with use of a rectangle, and also indicates an identifier of the detected object, and information (score) indicating accuracy of the detected object by labeling.

Patent Document 2 describes one example of an image processing apparatus devised in such a way that a verification result regarding a target object detected from an input image, or confirmation on a pass/fail determination result can be easily performed. The image processing apparatus in Patent Document 2 is an image processing apparatus including a target object detection unit that detects one or a plurality of images of a target object from an input image, based on a model pattern of the target object, and a detection result display unit that graphically displays a detection result in a superimposing manner. The detection result display unit includes a first frame displaying the entirety of an input image, and a second frame list-displaying a partial image including each of detected one or a plurality of images; a detection result is displayed in a superimposing manner with respect to all detected images in the input image being displayed in the first frame; and a detection result of an image associated with each of the partial images is displayed in a superimposing manner in the partial images being displayed in the second frame.

Further, Patent Document 3 describes one example of an image reproduction apparatus for making it easy to display a still image according to the number of subjects of persons. The image reproduction apparatus in Patent Document 2 determines whether the pixel number of a still image is more than a predetermined reference pixel number, when a plurality of still images are displayed as a slide show. Further, it is determined whether image resolution of a display for displaying a still image is lower than predetermined reference resolution. When these conditions are satisfied, a face of a person within a still image is detected, and it is determined whether the detected number of persons is more than a predetermined reference number of persons. When it is determined that the detected number of persons is more than the reference number of persons, the number of images to be cropped is determined according to the detected number of persons, and a plurality of images are cropped, based on a range within which persons of the number less than the reference number of persons are captured. Each of the plurality of cropped images is displayed equivalently to one still image. This extends a substantial reproduction time for displaying one still image, and displays each person largely.

### RELATED DOCUMENTS

### Patent Documents

Patent Document 1: Japanese Patent Application Publication No. 2020-190437

Patent Document 2: Japanese Patent Application Publication No. 2017-151813

Patent Document 3: Japanese Patent Application Publication No. 2006-309661

### SUMMARY OF INVENTION

### Technical Problem

Since a learning model influences an image analysis result, a measure for improving accuracy of a detection result can be taken by allowing an operator to view and confirm an image in which an object detection result is displayed, and analyzing tendency of the learning model.

The above-described technique described in Patent Document 1 is merely related to object detection using deep learning, and does not consider that a learning model is evaluated. Further, the technique described in Patent Documents 2 and 3 describes a technique for making it easy to confirm a plurality of target objects detected from an image, however, since a large number of detection results are displayed in an overlapping manner, like a detection result of object detection using deep learning, a situation that a content of a detection result cannot be confirmed is not considered.

In contrast, the inventor of the present application has studied an improvement proposal for solving a problem that evaluation work on a detection result of a learning model becomes difficult, since display of a rectangular frame indicating the detection result, an identifier of a detected object, and a score are overlapped in many ways, which makes it difficult to view the detection result, when the detection result of object detection using deep learning is confirmed.

In view of the above-described problem, one example of an object of the present invention is to provide a display assistance apparatus, a display assistance method, and a storage medium that are solve difficulty in evaluation work on a detection result of a learning model using deep learning.

### Solution to Problem

An example aspect of the present invention provides a display assistance apparatus including:
a detection result acquisition unit that acquires a detection result of an image including a plurality of detection targets, and in which detection processing of the detection target is performed;
a display processing unit that causes to display the acquired detection result of the image; and
an instruction acquisition unit that acquires information indicating an instruction to the detection result, wherein
the display processing unit sets a predetermined number of the detection targets, as a detection result display target, and causes to display position information indicating a position of the detection target within the image, and a score indicating certainty of the detection target in association with the image, and,
when the instruction acquisition unit acquires switching information indicating an instruction to switch the detection target serving as the detection result display target, the display processing unit switches the detection result display target to another of the detection target within the image, and causes to display the position information and the score related to the detection target after the switching.

An example aspect of the present invention provides a display assistance method including,
by one or more computers:
acquiring a detection result of an image including a plurality of detection targets, and in which detection processing of the detection target is performed;
causing to display the acquired detection result of the image;
setting a predetermined number of the detection targets, as a detection result display target, and causing to display position information indicating a position of the detection target within the image, and a score indicating certainty of the detection target in association with the image; and,
when switching information indicating an instruction to switch the detection target serving as the detection result display target is acquired, switching the detection result display target to another of the detection target within the image, and causing to display the position information and the score related to the detection target after the switching.

An example aspect of the invention provides a computer-readable storage medium storing a program for causing a computer to execute:
a procedure of acquiring a detection result of an image including a plurality of detection targets, and in which detection processing of the detection target is performed;
a procedure of causing to display the acquired detection result of the image;
a procedure of acquiring information indicating an instruction to the detection result;
a procedure of setting a predetermined number of the detection targets, as a detection result display target, and causing to display position information indicating a position of the detection target within the image, and a score indicating certainty of the detection target in association with the image; and,
when switching information indicating an instruction to switch the detection target serving as the detection result display target is acquired in the acquiring procedure, a procedure of switching the detection result display target to another of the detection target within the image, and causing to display the position information and the score related to the detection target after the switching.

Note that, the present invention may include a program to be stored in a computer-readable storage medium storing a program according to the example aspect of the present invention. The storage medium includes a non-transitory tangible medium.

The computer program includes a computer program code causing a computer to execute an authentication method on an authentication apparatus when the computer program is executed by the computer.

Note that, any combination of the above-described constituent elements, and a configuration acquired by converting expression of the present invention among a method, an apparatus, a system, a storage medium, a computer program, and the like are also available as an aspect of the present invention.

Further, various constituent elements of the present invention are not required to be necessarily individually independent elements, and a configuration in which a plurality of constituent elements are formed as one member, a configuration in which one constituent element is formed of a plurality of members, a configuration in which a certain constituent element is a part of another constituent element, a configuration in which a part of a certain constituent element and a part of another constituent element overlap with each other, and the like may also be available.

Further, a plurality of procedures are described in order in a method and a computer program of the present invention, but the order of the description does not limit an order in which a plurality of procedures are executed. Therefore, when a method and a computer program of the present invention are implemented, the order of the plurality of procedures can be changed within a range that a content is not impaired.

Furthermore, a plurality of procedures in a method and a computer program of the present invention are not limited to a configuration in which the procedures are executed at individually different timing. Therefore, a configuration in which another procedure occurs during execution of a certain procedure, a configuration in which execution timing of a certain procedure and execution timing of another procedure overlap partially or entirely, and the like may also be available.

### Advantageous Effects of Invention

According to an example aspect of the present invention, difficulty of evaluation work on a detection result of a learning model using deep learning can be solved.

### BRIEF DESCRIPTION OF THE DRAWINGS

FIG. 1 It is a diagram illustrating an overview of a display assistance apparatus according to an example embodiment.

FIG. 2 It is a flowchart illustrating one example of operation of the display assistance apparatus in FIG. 1.

FIG. 3 It is a diagram conceptually illustrating a system configuration of an image analysis system according to the example embodiment.

FIG. 4 It is a diagram illustrating an example of a detection result to be displayed on a display apparatus.

FIG. 5 It is a block diagram illustrating a hardware configuration of a computer implementing the display assistance apparatus illustrated in FIG. 1.

FIG. 6 It is a diagram illustrating a display example of a detection result of an image in the example embodiment.

FIG. 7 It is a diagram illustrating a display example of a detection result of an image in the example embodiment.

FIG. 8 It is a flowchart illustrating an operation example of a feature portion of the display assistance apparatus according to the example embodiment.

FIG. 9 It is a diagram illustrating a display example of a detection result of an image in the example embodiment.

FIG. 10 It is a diagram illustrating an example of an area cropped from an image in the example embodiment.

FIG. 11 It is a diagram illustrating a display example of a detection result of an image in the example embodiment.

FIG. 12 It is a diagram illustrating a display example of a detection result of an image in the example embodiment.

FIG. 13 It is a flowchart illustrating an operation example of the display assistance apparatus according to the example embodiment.

FIG. 14 It is a diagram illustrating a display example of a detection result of an image in the example embodiment.

FIG. 15 It is a diagram illustrating a display example of a detection result of an image in the example embodiment.

FIG. 16 It is a diagram illustrating a display example of a detection result of an image in the example embodiment.

FIG. 17 It is a diagram illustrating an overview of the display assistance apparatus according to the example embodiment.

### EXAMPLE EMBODIMENT

Hereinafter, example embodiments according to the present invention are described by using the drawings. Note that, in all drawings, a similar constituent element is indicated by a similar reference sign, and description thereof is not included, as necessary. Further, in the following each drawing, a configuration of a portion not being related to the essence of the present invention is not included, and is not illustrated.

In the example embodiments, “acquisition” includes at least one of fetching data or information stored in another apparatus or a storage medium by an own apparatus (active acquisition), and inputting data or information being output from another apparatus to an own apparatus (passive acquisition). Examples of active acquisition include requesting or inquiring another apparatus and receiving a reply thereof, accessing to another apparatus or a storage medium and reading, and the like. Further, examples of passive acquisition include receiving information being distributed (or transmitted, push notified, or the like), and the like. Furthermore, “acquisition” may include selecting and acquiring from received data or information, or selecting and receiving distributed data or information.

### Minimum Configuration Example

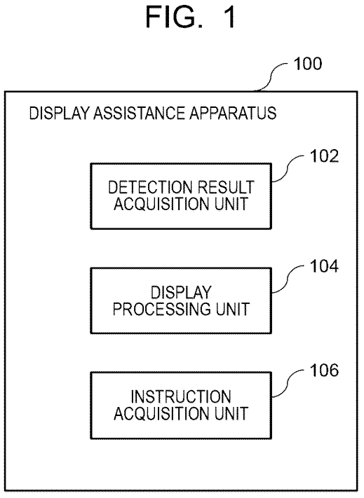

FIG. 1 is a diagram illustrating an overview of a display assistance apparatus 100 according to an example embodiment. The display assistance apparatus 100 includes a detection result acquisition unit 102, a display processing unit 104, and an instruction acquisition unit 106.

The detection result acquisition unit 102 acquires a detection result of an image including a plurality of detection objects, and in which detection processing of the detection target is performed.

The display processing unit 104 causes to display the acquired detection result of the image.

The instruction acquisition unit 106 acquires information indicating an instruction to the detection result.

The display processing unit 104 sets a predetermined number of detection targets, as a detection result display target, causes to display position information indicating a position of the detection target within the image, and a score indicating certainty of the detection target in association with the image, and, when the instruction acquisition unit 106 acquires switching information indicating an instruction to switch the detection target serving as the detection result display target, the display processing unit 104 switches the detection result display target to another detection target within the image, and causes to display position information and a score related to the detection target after the switching.

The display processing unit 104 causes a display apparatus (not illustrated) to be connected to the display assistance apparatus 100 to display an image serving as a target, and also causes to display the detection result in a superimposing manner. Since the number of detection results becomes plural, it becomes difficult to view the display, and thereby the display processing unit 104 causes to display a predetermined number of detection targets, as the detection result display target. The predetermined number is, for example, one, but may be plural.

### Operation Example

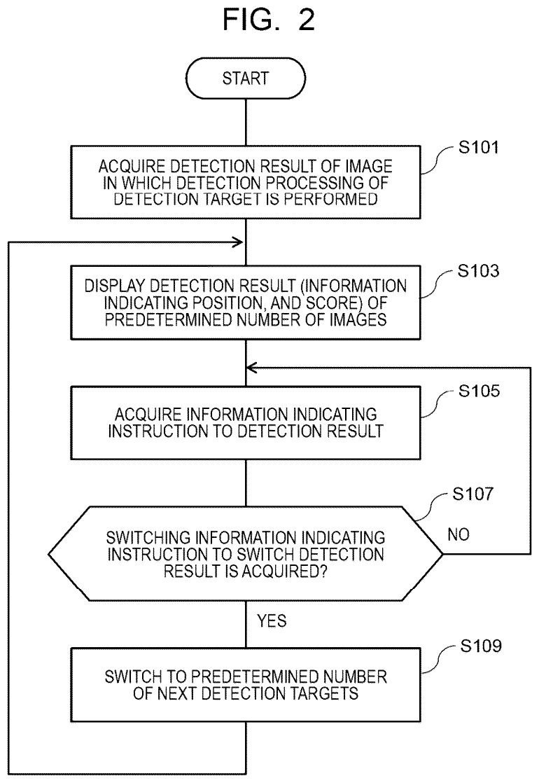

FIG. 2 is a flowchart illustrating one example of operation of the display assistance apparatus 100 in FIG. 1.

First, in the display assistance apparatus 100, the detection result acquisition unit 102 acquires a detection result of an image including a plurality of detection targets, and in which detection processing of the detection target is performed (step S101). Then, the display processing unit 104 sets a predetermined number of the detection results, as a detection result display target, and causes to display position information indicating a position of the detection target within the image, and a score indicating certainty of the detection target in association with the image (step S103). Then, the instruction acquisition unit 106 acquires information indicating an instruction to the detection result (step S105). When the instruction acquisition unit 106 acquires switching information indicating an instruction to switch the detection target serving as the detection result display target (YES in step S107), the display processing unit 104 switches the detection result display target to another detection target within the image (step S109), proceeds to step S103, and causes to display a predetermined number of pieces of position information and scores related to the detection target after the switching.

As described above, in the display assistance apparatus 100, the detection result acquisition unit 102 acquires a detection result of an image, the display processing unit 104 causes a display apparatus 110 to display a predetermined number of detection targets, as a detection result display target, from among the acquired detection result. Then, when the instruction acquisition unit 106 acquires switching information indicating an instruction to switch the detection target serving as the detection result display target, the display processing unit 104 switches the detection result display target to another detection target within the image, and causes to display position information and a score related to the detection target after the switching.

Thus, according to the display assistance apparatus 100, since each predetermined number of detection results can be switched and displayed from among a large number of detection results, a detection result is made easy to be viewed, and an advantageous effect that difficulty in evaluation work on a detection result of a learning model using deep learning can be solved is achieved.

Hereinafter, detail examples of the display assistance apparatus 100 are described.

### First Example Embodiment

### System Overview

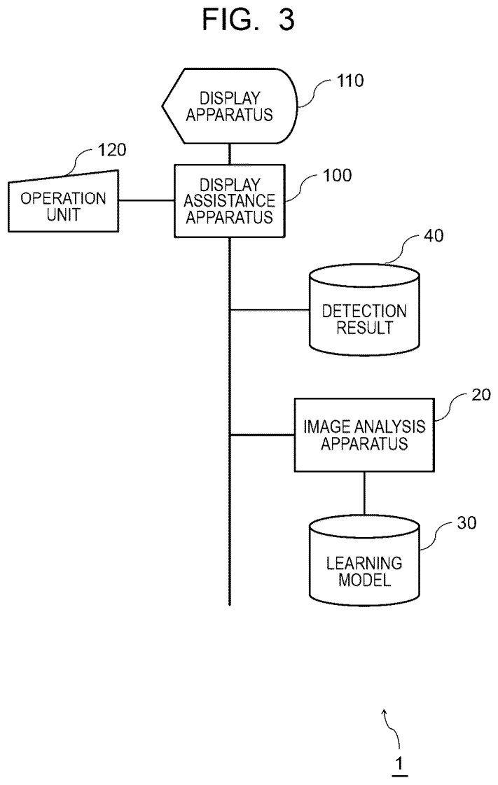

FIG. 3 is a diagram conceptually illustrating a system configuration of an image analysis system 1 according to an example embodiment.

The image analysis system 1 includes a display assistance apparatus 100, and an image analysis apparatus 20. The image analysis apparatus 20 performs object detection by analyzing an image by deep learning with use of a learning model 30, and stores a detection result in a detection result storage unit 40. The display assistance apparatus 100 is connected to a display apparatus 110 and an operation unit 120. The display apparatus 110 is a liquid crystal display, an organic electro-luminescence (EL) display, or the like. The operation unit 120 is a keyboard, a mouse, and the like. The display apparatus 110 and the operation unit 120 may be an integral touch panel.

The display assistance apparatus 100 causes the display apparatus 110 to display a detection result analyzed by the image analysis apparatus 20. An operator views and confirms a detection result displayed on the display apparatus 110, and analyzes tendency of the learning model 30.

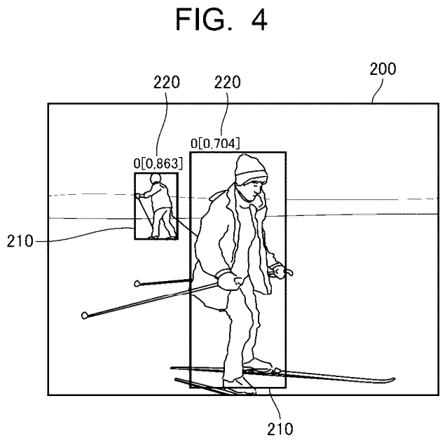

FIG. 4 is a diagram illustrating an example of a detection result to be displayed on the display apparatus 110. Position information (a rectangular frame 210) indicating a position of a detection target within an image, and a label 220 including a score indicating certainty of the detection target are displayed in an image 200 of the detection target in a superimposing manner.

In this example, the label 220 includes identification information (e.g., in a case of a person, “0”) indicating a category of a detected object, and a score. The category of an object serving as a detection target is, for example, a person, food, a car, and the like.

The score is a score which is generated by a deep learning learning model. The score is, for example, indicated by a value from 0 to 1 (numerical value in which the number of decimal places is three), and the larger the numerical value is, it indicates that certainty of a detection result is high. In this example, the score is surrounded by [square brackets]. The identification information is indicated before the [square brackets]. However, these are one example, and a display method of the label 220 is not limited thereto.

Since the score which is generated by a deep learning learning model is, for example, indicated by a numerical value with three decimal places, and displayed by attaching the label 220 for each detection target, the greater the number of the detection targets within the image 200, the more detection targets are displayed in an overlapping manner, which makes it difficult to confirm the score. However, according to the present example embodiment, since each predetermined number of detection targets can be switched and displayed, the detection targets can be easily confirmed even in a score of a deep learning learning model.

### Hardware Configuration Example

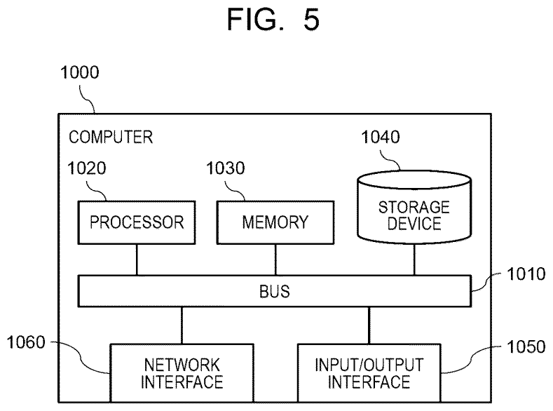

FIG. 5 is a block diagram illustrating a hardware configuration of a computer 1000 implementing the display assistance apparatus 100 illustrated in FIG. 1. The image analysis apparatus 20 of the image analysis system 1 in FIG. 3 is also implemented by the computer 1000.

The computer 1000 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor implemented by a central processing unit (CPU), a graphics processing unit (GPU), or the like.

The memory 1030 is a main storage apparatus implemented by a random access memory (RAM) or the like.

The storage device 1040 is an auxiliary storage apparatus implemented by a hard disk drive (HDD), a solid state drive (SSD), a memory card, a read only memory (ROM), or the like. The storage device 1040 stores a program module achieving each function (e.g., the detection result acquisition unit 102, the display processing unit 104, and the instruction acquisition unit 106 that are in FIG. 1, a storage processing unit 108, and the like) of the display assistance apparatus 100. Each function associated with a program module is implemented by causing the processor 1020 to read each program module in the memory 1030 and execute the program module. Further, the storage device 1040 also functions as a storage apparatus (not illustrated) storing various pieces of information to be used by the display assistance apparatus 100, or an evaluation result storage unit 130. Further, the storage device 1040 may also function as a storage apparatus (e.g., the learning model 30, or the detection result storage unit 40) storing various pieces of information to be used by the image analysis apparatus 20.

A program module may be stored in a storage medium. A storage medium storing a program module includes a non-transitory tangible medium usable by the computer 1000, and a program code readable by the computer 1000 (processor 1020) may be embedded in the medium. The input/output interface 1050 is an interface for connecting the computer 1000 to various pieces of input/output equipment.

The network interface 1060 is an interface for connecting the computer 1000 to a communication network. The communication network is, for example, a local area network (LAN) or a wide area network (WAN). A method of connecting the network interface 1060 to the communication network may be wireless connection, or may be wired connection. However, there is a case that the network interface 1060 is not used.

Further, the computer 1000 is connected to necessary equipment (e.g., the display apparatus 110, and the operation unit 120 of the display assistance apparatus 100, and the like) via the input/output interface 1050 or the network interface 1060.

Each of the display assistance apparatus 100 and the image analysis apparatus 20 may be implemented by a plurality of the computers 1000. Alternatively, the display assistance apparatus 100 may be incorporated in the image analysis apparatus 20. The computer 1000 implementing the display assistance apparatus 100 or the image analysis apparatus 20 may be a personal computer, or may be a server computer. The display assistance apparatus 100 may be a tablet terminal, or a smartphone.

The image analysis apparatus 20 may be an apparatus to be incorporated in an apparatus in which an image analysis is necessary in various fields.

Each constituent element of the display assistance apparatus 100 according to each example embodiment in FIG. 1 is implemented by any combination of hardware and software of the computer 1000 in FIG. 5. Further, it should be understood by a person skilled in the art that there are various modification examples as a method and an apparatus for implementing the display assistance apparatus 100. A functional block diagram illustrating the display assistance apparatus 100 according to each example embodiment does not illustrate a configuration on the basis of hardware, but illustrates a block on the basis of a logical function.

### Functional Configuration Example

Hereinafter, a functional configuration example of the display assistance apparatus 100 is described in detail by using FIG. 1.

The detection result acquisition unit 102 acquires a detection result of the image 200 from the detection result storage unit 40. The detection result includes an identifier indicating a category of an object detected from the image 200, position information (e.g., coordinate position information (ymin, xmin, ymax, xmax) of the rectangular frame 210 in the image 200) indicating a position of the object, and a score indicating certainty of a recognition result.

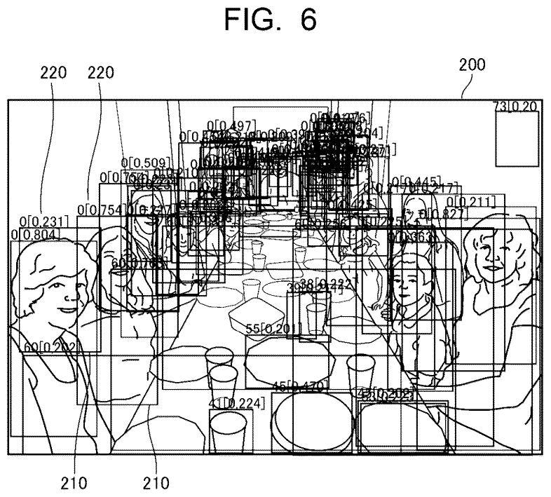

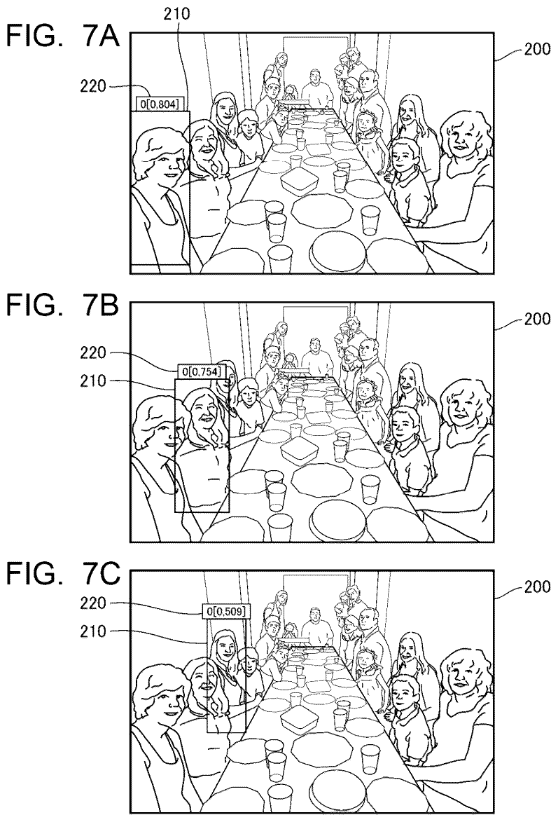

The display processing unit 104 causes to display a detection result of the image 200. FIGS. 6 and 7 are diagrams indicating a display example of a detection result of the image 200. FIG. 6 illustrates an example in which all detection results of the image 200 are indicated. Since a large number of detection results overlap one another, it is clear that scores are also difficult to be viewed.

In view of the above, the display processing unit 104 sets a predetermined number of detection targets, as a detection result display target, and causes to display the rectangular frame 210 and the label 220 in association with the image 200. In the example in FIG. 7, detection results within the image 200 are displayed one by one.

The position information is a rectangle surrounding a detection target in the image 200. The display processing unit 104 depicts a rectangle surrounding a detected target in the image 200. The display processing unit 104 causes to display a score outside of the rectangle.

However, the position information may be in another form, may be an ellipse surrounding a detection target, or may be an arrow or a ballon pointing a detection target. In the case of an arrow, a score may be displayed at a root of a mark. In the case of a ballon, a score may be displayed within the ballon.

Since the position information is displayed by a rectangle surrounding a detection target, an operator can recognize the detection target at a glance.

The instruction acquisition unit 106 acquires switching information indicating an instruction to switch a detection target serving as a detection result display target. The instruction acquisition unit 106 acquires, as the switching information of a detection target, an input from an operator.

The switching information may include direction information indicating a direction in which a detection target serving as a detection result display target is switched. The display processing unit 104 causes to display position information and a score by setting a detection target located in a direction indicated by input direction information, as a next detection result display target, from among a detection target being a current detection result display target.

An input example from an operator is exemplified in the following, but is not limited thereto. A plurality of these examples may be combined.
(1) Move up and down, or left and right; or up and down, and left and right by depressing an arrow key on a keyboard
(2) Scroll up and down by a wheel operation of a mouse
(3) Instruction such as “next” or “return”, instruction such as “up”, “down”, “right”, or “left” by voice

When the instruction acquisition unit 106 acquires switching information, the display processing unit 104 switches a detection result display target to another detection target within the image 200, and causes to display position information (rectangular frame 210) and a score (label 220) related to the detection target after the switching.

Since the instruction acquisition unit 106 switches the detection target in response to an input by an operator, it is possible to display a detection result by switching the detection target at timing of the operator, which makes it easy to confirm an individual detection result.

Further, since a switching direction of a detection target can be specified by using an arrow key or the like, intention of the operator is easily reflected, and operability is improved.

Further, the instruction acquisition unit 106 may set as, switching information of a detection target, an output of a timer indicating a lapse of a predetermined time. In this case, the display processing unit 104 automatically switches and displays a detection target each time a predetermined time elapses.

### Operation Example

Hereinafter, operation of the display assistance apparatus 100 according to the example embodiment is described by using FIG. 2.

First, the detection result acquisition unit 102 acquires, from the detection result storage unit 40, a detection result of an image including a plurality of detection targets, and in which detection processing of the detection target is performed (step S101).

Then, the display processing unit 104 sets a predetermined number (one in the example in FIG. 7) of the detection targets, as a detection result display target, and causes to display position information (rectangular frame 210) indicating a position of the detection target within the image 200, and a score (label 220) indicating certainty of the detection target in association with the image 200 (step S103). First, an image 200 in FIG. 7(a) is displayed on the display apparatus 110.

Then, the instruction acquisition unit 106 acquires information indicating an instruction to the detection result (step S105). Herein, it is assumed that an operator depresses an upward arrow key on a keyboard (operation unit 120). The instruction acquisition unit 106 acquires information indicating that the upward arrow key is depressed.

When the instruction acquisition unit 106 acquires switching information (depressing the upward arrow key) (YES in step S107), the display processing unit 104 switches the detection result display target to another detection target within the image 200 (step S109), proceeds to step S103, and causes to display a predetermined number (one in the example) of pieces of position information (rectangular frame 210) and scores (label 220) related to the detection target after the switching. Herein, an image 200 in FIG. 7(b) is displayed on the display apparatus 110.

In the image 200 in FIG. 7(a), the position information (rectangular frame 210) and the score (label 220) are displayed in a superimposing manner, as a detection result, on a person closest to the front, but in the image 200 in FIG. 7(b), the detection result is switched to a person (person second closest to the front) behind the person closest to the front, and the position information (rectangular frame 210) and the score (label 220) are displayed in a superimposing manner.

Furthermore, it is assumed that an operator depresses the upward arrow key on the keyboard (operation unit 120). The instruction acquisition unit 106 acquires information indicating that the upward arrow key is depressed.

When the instruction acquisition unit 106 acquires switching information (depressing the upward arrow key) (YES in step S107), the display processing unit 104 switches the detection result display target to another detection target within the image 200 (step S109), proceeds to step S103, and causes to display a predetermined number (one in the example) of pieces of position information (rectangular frame 210) and scores (label 220) related to the detection target after the switching. Herein, an image 200 in FIG. 7(c) is displayed on the display apparatus 110.

In the image 200 in FIG. 7(b), the position information (rectangular frame 210) and the score (label 220) are displayed in a superimposing manner, as a detection result, on the person second closest to the front, but in the image 200 in FIG. 7(c), the detection result is switched to a person (person third closest to the front) further behind the person second closest to the front, and the position information (rectangular frame 210) and the score (label 220) are displayed in a superimposing manner.

As described above, in the display assistance apparatus 100, a detection result of an image analyzed by a deep learning learning model with use of the image analysis apparatus 20 is acquired by the detection result acquisition unit 102, and a predetermined number of detection results are displayed, by the display processing unit 104, on the display apparatus 110, as a detection result display target, from among the acquired detection result. Then, when the instruction acquisition unit 106 acquires switching information indicating an instruction to switch the detection target serving as the detection result display target, the display processing unit 104 switches the detection result display target to another detection target within the image, and causes to display position information and a score related to the detection target after the switching.

Thus, according to the display assistance apparatus 100, since each predetermined number of detection results can be switched and displayed from among a large number of detection results, a detection result is made easy to be viewed, and an advantageous effect that difficulty in evaluation work on a detection result of a learning model using deep learning can be solved is achieved.

### Second Example Embodiment

The present example embodiment is similar to the above-described example embodiment except for a point that a configuration in which a part of an image is cropped, and a detection target result is displayed is included. Since a display assistance apparatus 100 according to the present example embodiment includes the same configuration as that of the first example embodiment, the present example embodiment is described by using FIG. 1. Note that, a configuration of the present example embodiment may be combined with at least one of configurations of other example embodiments within a range that does not cause inconsistency.

### Functional Configuration Example

An instruction acquisition unit 106 acquires area specification information indicating an instruction to specify an area 240 being a part within an image 200, and including a plurality of detection targets. When the instruction acquisition unit 106 acquires area specification information, a display processing unit 104 crops the specified area 240 from the image 200, causes to display the specified area 240, and causes to display position information (rectangular frame 210) and a score (220) regarding a predetermined number of detection targets included in the area 240.

### Operation Example

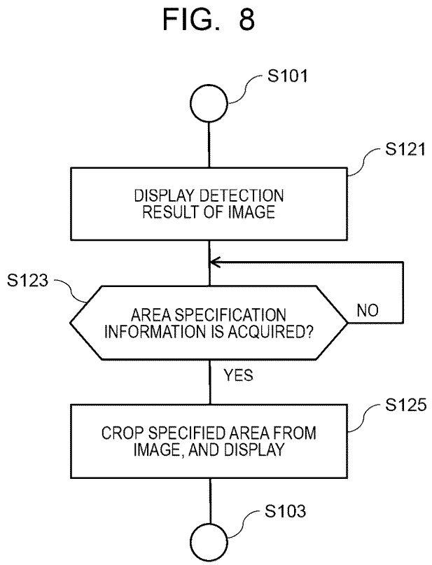

FIG. 8 is a flowchart illustrating an operation example of a feature portion of the display assistance apparatus 100 according to the example embodiment. The flowchart in FIG. 8 is executed between step S101 and step S103 in FIG. 2. Hereinafter, the example embodiment is described by using a diagram illustrating an example of an image 200 in FIGS. 6 and 9 to 11.

In step S101, after a detection result acquisition unit 102 acquires a detection result of the image 200 from a detection result storage unit 40, the display processing unit 104 causes to display, on a display apparatus 110, the detection result of the image 200 acquired in step S101 (step S121). At this occasion, the image 200 in FIG. 6 is displayed on the display apparatus 110.

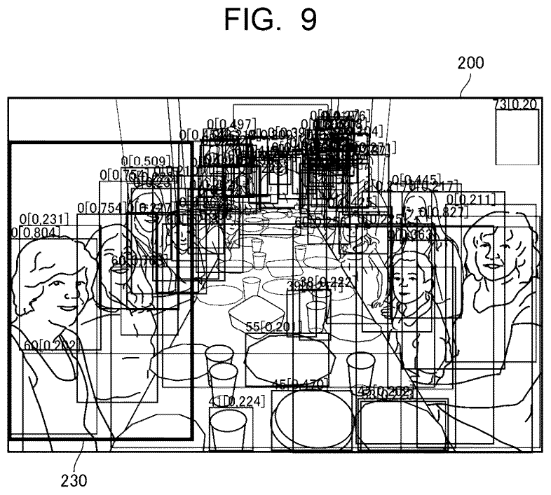

Then, it is assumed that an operator specifies the area 240 being a part within the image 200, and including a plurality of detection targets by using an operation unit 120 (e.g., a mouse). In FIG. 9, an area is specified by a rectangle 230.

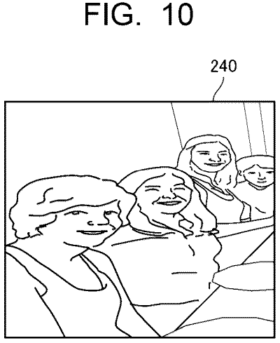

When the instruction acquisition unit 106 acquires area specification information (YES in step S123), the display processing unit 104 crops the specified area 240 from the image 200, and causes to display the specified area 240 (step S125). FIG. 10 is a diagram illustrating an example of the cropped area 240. At this occasion, the area 240 is preferably displayed largely. A magnification ratio may be specified by an operator. Alternatively, enlargement or reduction may be allowed by allowing the operator to pinch out or pinch in the area 240.

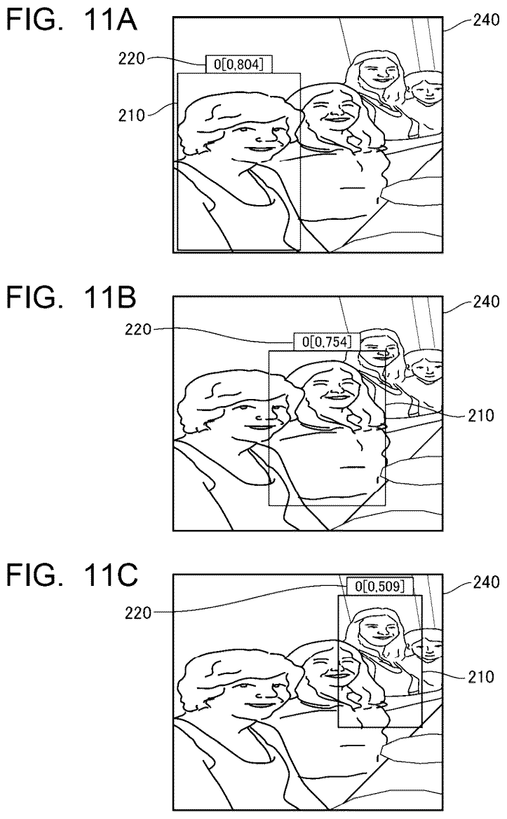

Then, proceeding to step S103 in FIG. 2. The display processing unit 104 sets a predetermined number (one in the example in FIG. 11) of the detection targets, as a detection result display target, and causes to display position information (rectangular frame 210) indicating a position within the image 200 of the detection target, and a score (label 220) indicating certainty of the detection target in association with the image 200 (step S103). First, an image 200 in FIG. 11(a) is displayed on the display apparatus 110.

Then, the instruction acquisition unit 106 acquires information indicating an instruction to the detection result (step S105). Herein, it is assumed that an operator depresses an upward arrow key on a keyboard (operation unit 120). The instruction acquisition unit 106 acquires information indicating that the upward arrow key is depressed.

When the instruction acquisition unit 106 acquires switching information (depressing the upward arrow key) (YES in step S107), the display processing unit 104 switches the detection result display target to another detection target within the image 200 (step S109), proceeds to step S103, and causes to display a predetermined number (one in the example) of pieces of position information (rectangular frame 210) and scores (label 220) related to the detection target after the switching. Herein, an image 200 in FIG. 11(b) is displayed on the display apparatus 110.

In the image 200 in FIG. 11(a), the position information (rectangular frame 210) and the score (label 220) are displayed in a superimposing manner, as a detection result, on a person closest to the front, but in the image 200 in FIG. 11(b), the detection result is switched to a person (person second closest to the front) behind the person closest to the front, and the position information (rectangular frame 210) and the score (label 220) are displayed in a superimposing manner.

Furthermore, it is assumed that an operator depresses the upward arrow key on the keyboard (operation unit 120). The instruction acquisition unit 106 acquires information indicating that the upward arrow key is depressed.

When the instruction acquisition unit 106 acquires switching information (depressing the upward arrow key) (YES in step S107), the display processing unit 104 switches the detection result display target to another detection target within the image 200 (step S109), proceeds to step S103, and causes to display a predetermined number (one in the example) of pieces of position information (rectangular frame 210) and scores (label 220) related to the detection target after the switching. Herein, an image 200 in FIG. 11(c) is displayed on the display apparatus 110.

In the image 200 in FIG. 11(b), the position information (rectangular frame 210) and the score (label 220) are displayed in a superimposing manner, as a detection result, on the person second closest to the front, but in the image 200 in FIG. 11(c), the detection result is switched to a person (person third closest to the front) further behind the person second closest to the front, and the position information (rectangular frame 210) and the score (label 220) are displayed in a superimposing manner.

As described above, in the display assistance apparatus 100, when the instruction acquisition unit 106 crops a part of the image 200, and acquires area specification information specifying the area 240 including a plurality of detection targets, the display processing unit 104 crops the specified area 240 from the image 200, and causes to display position information (rectangular frame 210) and a score (label 220) for a predetermined number of detection targets included in the area 240.

Thus, the display assistance apparatus 100 achieves a similar advantageous effect to that of the above-described example embodiment, and furthermore, since a detection result can be confirmed by cutting out a particularly noteworthy area 240, or an area 240 in which detection targets are included in a crowded manner, a detection result can be more easily viewed.

### Modification Aspect of Second Example Embodiment

In the second example embodiment, a display processing unit 104 crops an area 240 according to area specification information, and causes to display the area 240. As a modification aspect, it may be limited that the area 240 is not cropped, and only a display target of a detection result is displayed in the area 240.

For example, as exemplified in FIG. 9, when an operator specifies an area in an image 200 by a rectangle 230, an instruction acquisition unit 106 acquires area specification information. Then, the display processing unit 104 successively switches a detection result and causes to display the detection result, as illustrated in FIGS. 7(a) to 7(c), each time when the instruction acquisition unit 106 acquires switching information regarding a plurality of detection targets within an area associated with the area 240 specified by the rectangle 230.

According to this configuration, since a detection result can be confirmed regarding a particularly noteworthy area 240, work efficiency can be improved.

### Third Example Embodiment

The present example embodiment is similar to the first example embodiment except for a point that a configuration in which detection results of a plurality of detection targets are displayed in a list, and a search target in which the detection result is displayed on an image by selecting the list display is switched is included. Since a display assistance apparatus 100 according to the present example embodiment includes the same configuration as that of the first example embodiment, the present example embodiment is described by using FIG. 1. Note that, a configuration of the present example embodiment may be combined with at least one of configurations of other example embodiments within a range that does not cause inconsistency.

### Functional Configuration Example

A display processing unit 104 causes to display detection results of a plurality of detection targets in a list. An instruction acquisition unit 106 acquires selection information indicating a detection target selected from the list display. The display processing unit 104 causes to display a search result of the detection target indicated by the selection information in association with an image 300.

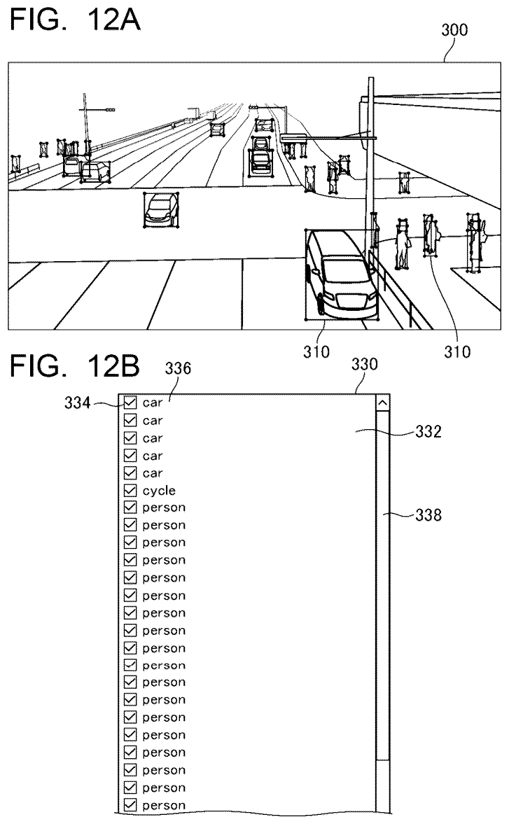

FIG. 12 is a diagram illustrating a display example of a detection result of the image 300 in the example embodiment. Position information (rectangular frame 310) indicating a position of a detection target is displayed in an image 300 in FIG. 12 (a). FIG. 12(b) is a diagram illustrating an example of a search result list 330. The search result list 330 may be displayed in a window other than a window for the image 300, for example. The two windows may be displayed side by side. One record (row) is allocated to each detected object in the search result list 330.

A checkbox 334, and an identification information display portion 336 are included for each record 332. Since a plurality of the records 332 are included in the search result list 330, a scroll bar 338 may be included. The checkbox 334 is a user interface (UI) accepting specification as to whether a rectangular frame 310 surrounding an object being a detection target associated with the record 332 is to be displayed in the image 300. For example, when the checkbox 334 is checked, the display processing unit 104 causes to display the rectangular frame 310 associated with the image 300, and when the checkbox is unchecked, the rectangular frame 310 is hidden from the image 300. A category of an object being a detection target is displayed in the identification information display portion 336.

The display processing unit 104 causes to display detection results in a batch manner for each attribute of a detection target. Herein, an attribute of a detection target is a category of an object. However, the attribute of a detection target is not limited thereto. For example, in a case of a person, gender is included in the attribute, and a detection result may be the one in which the attribute of a person is also recognized.

Further, for example, a plurality of the records 332 in the search result list 330 may be sorted and displayed for each category of an object. The display processing unit 104 sorts the records 332 for each category of a detection result of a detection target of the record 332, and causes to display the search result list 330. In the example, the category includes a car, a cycle, and a person. Further, the display processing unit 104 may perform color coding for a background color of the identification information display portion 336 for each category, and cause to display the background color. In another example, specification of the category may be accepted, and a detection result of a detection target of the category for which specification is accepted may be selected in a batch manner, or selection may be released.

### Operation Example

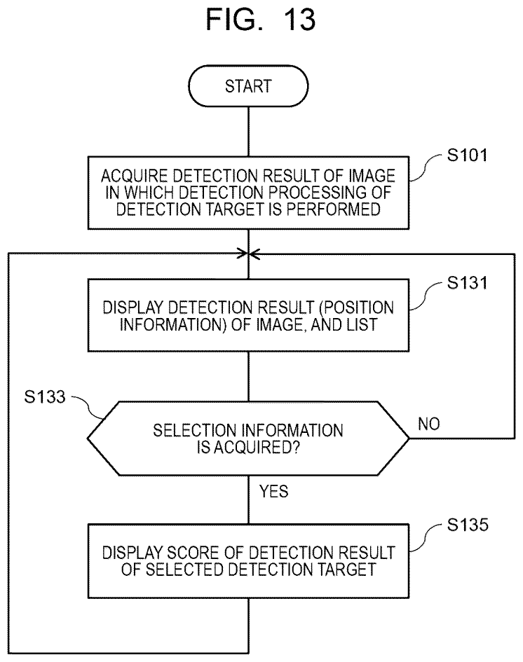

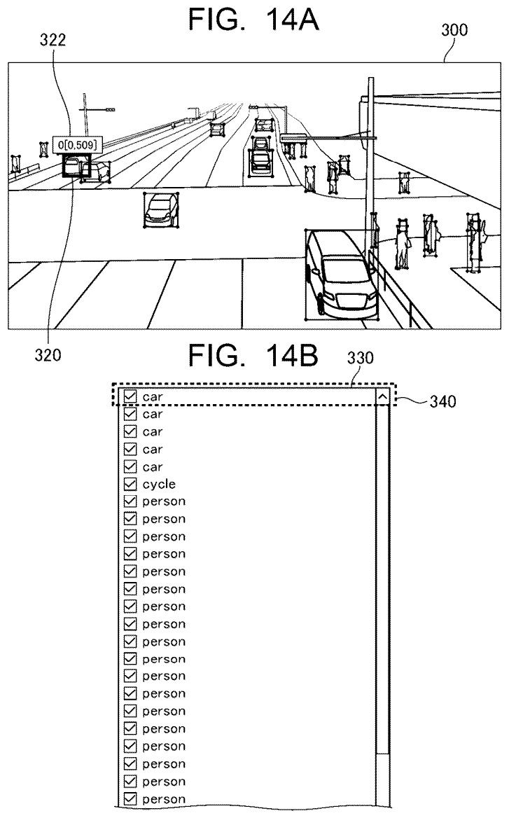

FIG. 13 is a flowchart illustrating an operation example of the display assistance apparatus 100 according to the example embodiment. Further, FIGS. 14 to 16 are diagrams illustrating a display example of a detection result of the image 300 in the example embodiment.

The flow in FIG. 13 includes the same step S101 as in the case of FIG. 2, and includes step S131 to step S135 after step S101.

First, a detection result acquisition unit 102 acquires, from a detection result storage unit 40, a detection result of an image including a plurality of detection targets, and in which detection processing of the detection target is performed (step S101). Then, the display processing unit 104 causes to display, on a display apparatus 110, the image 300 and the search result list 330 in FIG. 12 (step S131). Then, when the instruction acquisition unit 106 acquires selection information of a record 340, as exemplified in FIG. 14(b) (YES in step S133), as illustrated in FIG. 13(a), the display processing unit 104 causes to display, in the image 300, a score (a label 322 including identification information of the category, and a score) of a detection result of the selected detection target (step S135).

In step S133, one record 340 is selected, but a plurality of records 332 may be allowed to be selected.

The display processing unit 104 may perform emphasis display 320 of position information (rectangular frame 310) indicating a position of a detection result of the selected detection target. For example, a color of the rectangular frame 310 may be changed, a frame line may be thickened, the rectangular frame 310 may be displayed in a blinking manner or may be displayed in a shading manner, or these may be combined.

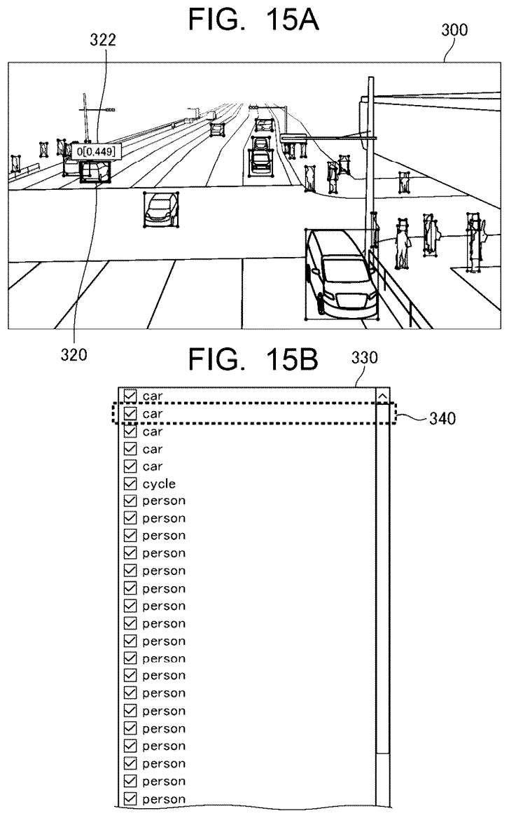

Furthermore, as illustrated in FIG. 15(b), when an operator selects a next record 340, the instruction acquisition unit 106 acquires selection information of the record 340 (YES in step S133). Then, as illustrated in FIG. 15(a), the display processing unit 104 causes to display, in the image 300, a score (a label 322 including identification information of the category and a score, and emphasis display 320) of a detection result of the selected detection target (step S135). In FIG. 14(a) to FIG. 15(a), the detection target in which the label 322 and the emphasis display 320 are displayed is moved to an adjacent detection target.

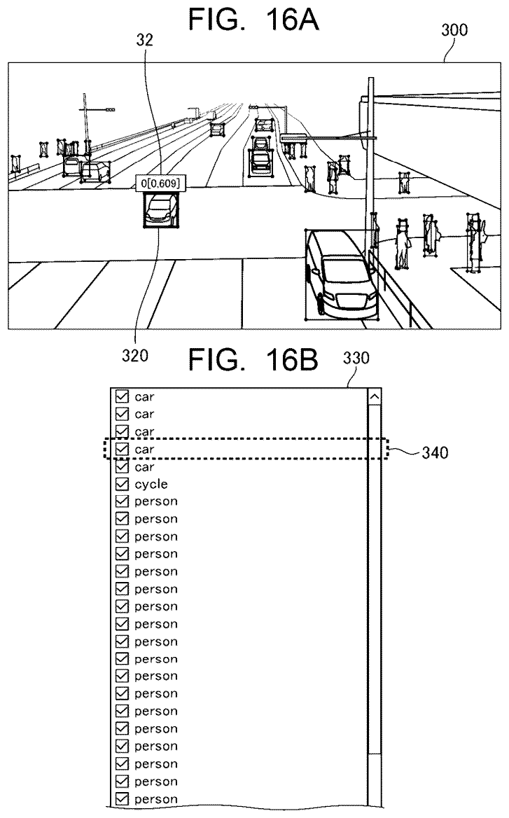

In the example in FIG. 16, when an operator further selects another record 340, the instruction acquisition unit 106 acquires selection information of the record 340 (YES in step S133). Then, as illustrated in FIG. 16(a), the display processing unit 104 causes to display, in the image 300, a score (a label 322 including identification information of the category and a score, and emphasis display 320) of a detection result of the selected detection target (step S135). In FIG. 15(a) to FIG. 16(a), the detection target in which the label 322 and the emphasis display 320 are displayed is moved to an adjacent detection target.

As described above, in the display assistance apparatus 100 according to the present example embodiment, the display processing unit 104 causes to display detection results of a plurality of detection targets in a list, and when the instruction acquisition unit 106 acquires selection information indicating a detection target selected from the list display, the display processing unit 104 causes to display a search result (such as the label 322) of the detection target indicated by the selection information in association with the image 300. Further, the display processing unit 104 causes to display detection results in a batch manner for each attribute of the detection target.

Thus, first of all, a plurality of detection results can be browsed by the search result list 330. Then, the search result list 330 can be confirmed for each category of a detection target, a large number of detection targets can be confirmed systematically, and efficiency of analysis work can be improved.

### Fourth Example Embodiment

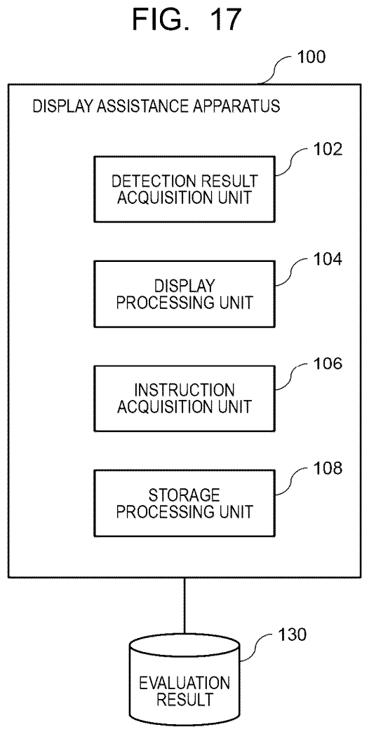

The present example embodiment is similar to any of the above-described example embodiments except for a point that a configuration in which a detection result can be selected and stored is included. FIG. 17 is a diagram illustrating an overview of a display assistance apparatus 100 according to the example embodiment.

Functional Configuration Example The display assistance apparatus 100 according to the example embodiment further includes a storage processing unit 108, in addition to the configuration in FIG. 1. An instruction acquisition unit 106 acquires selection information indicating an instruction to select a detection target. The storage processing unit 108 causes to store, in an evaluation result storage unit 130, a detection result of the selected detection target.

An operator can select and store a detection result desired to be confirmed later. For example, a detection result in which a score is lower than a predetermined value can be selected and stored, and can be confirmed or the like in a batch manner later at a time of analysis. Further, since a detection result of another image can also be stored together in the evaluation result storage unit 130, a detection result of a detection target included in the another image can also be analyzed together for the images.

As described above, according to the display assistance apparatus 100, since the storage processing unit 108 causes to store, in the evaluation result storage unit 130, a detection result of a detection target selected by selection information acquired by the instruction acquisition unit 106, for example, an image of a detection result in which a score is low can be confirmed later in a batch manner by selecting and storing the detection result in which the score is low, and thereby efficiency of analysis work can be improved.

In the foregoing, the example embodiments according to the present invention have been described with reference to the drawings, however, these are examples of the present invention, and various configurations other than the above can also be adopted.

For example, in a configuration of any of the above-described example embodiments, as switching information, a detection result of a detection target is successively switched and displayed by depressing an arrow key or a scroll operation of a mouse by an operator, however, selection of a detection target may be released, and display of all detection results may be returned by depressing an enter key, an escape key, or the like.

Further, in a plurality of flowcharts used in the above description, a plurality of processes (pieces of processing) are described in order, however, an order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

While the invention of the present application has been described with reference to the example embodiments, the invention of the present application is not limited to the above-described example embodiments. A configuration and details of the invention of the present application may be modified in various ways comprehensible to a person skilled in the art within the scope of the invention of the present application.

Note that, in a case where information related to a user (operator) is acquired and used in the present invention, the acquisition and the usage are assumed to be performed legally.

A part or all of the above-described example embodiments may also be described as the following supplementary notes, but is not limited to the following.
1. A display assistance apparatus including:
   a detection result acquisition unit that acquires a detection result of an image including a plurality of detection targets, and in which detection processing of the detection target is performed;
   a display processing unit that causes to display the acquired detection result of the image; and
   an instruction acquisition unit that acquires information indicating an instruction to the detection result, wherein
   the display processing unit sets a predetermined number of the detection targets, as a detection result display target, and causes to display position information indicating a position of the detection target within the image, and a score indicating certainty of the detection target in association with the image, and,
   when the instruction acquisition unit acquires switching information indicating an instruction to switch the detection target serving as the detection result display target, the display processing unit switches the detection result display target to another of the detection target within the image, and causes to display the position information and the score related to the detection target after the switching.
2. The display assistance apparatus according to 1., wherein
   the position information is a rectangle surrounding the detection target in the image, and
   the display processing unit causes to display the score outside of the rectangle.
3. The display assistance apparatus according to 1. or 2., wherein,
   when the instruction acquisition unit acquires area specification information indicating an instruction to specify an area being a part within the image, and including a plurality of detection targets, the display processing unit crops the specified area from the image and causes to display the area, and causes to display the position information and the score regarding the predetermined number of the detection targets included in the area.
4. The display assistance apparatus according to any one of 1. to 3., wherein
   the instruction acquisition unit acquires, as switching information on the detection target, an input from an operator.
5. The display assistance apparatus according to any one of 1. to 4., wherein
   the switching information includes direction information indicating a switching direction of the detection target serving as the detection result display target, and
   the display processing unit
      causes to display the position information and the score by setting the detection target located in the direction indicated by the input direction information, as the next detection result display target from among the detection target being the current detection result display target.
6. The display assistance apparatus according to any one of 1. to 5., wherein
   the display processing unit
      causes to display a detection result of a plurality of the detection targets in a list,
   the instruction acquisition unit acquires selection information indicating the detection target selected from the list display, and
   the display processing unit causes to display a search result of the detection target indicated by the selection information in association with the image.
7. The display assistance apparatus according to 6., wherein
   the display processing unit
      causes to display the detection result in a batch manner for each attribute of the detection result.
8. The display assistance apparatus according to any one of 1. to 7., wherein
   the score is a score which is generated by a learning model.
9. The display assistance apparatus according to any one of 1. to 8., wherein
   the instruction acquisition unit acquires information indicating an instruction to select the detection target,
   the display assistance apparatus further including
   a storage processing unit that causes a storage unit to store a detection result of the selected detection target.
10. A display assistance method including,
   by one or more computers:
   acquiring a detection result of an image including a plurality of detection targets, and in which detection processing of the detection target is performed;
   causing to display the acquired detection result of the image;
   setting a predetermined number of the detection targets, as a detection result display target, and causing to display position information indicating a position of the detection target within the image, and a score indicating certainty of the detection target in association with the image; and,
   when switching information indicating an instruction to switch the detection target serving as the detection result display target is acquired, switching the detection result display target to another of the detection target within the image, and causing to display the position information and the score related to the detection target after the switching.
11. The display assistance method according to 10., wherein
   the position information is a rectangle surrounding the detection target in the image,
   the display assistance method further including,
   by the one or more computers,
   causing to display the score outside of the rectangle.
12. The display assistance method according to 10. or 11., further including,
   by the one or more computers,
   when area specification information indicating an instruction to specify an area being a part within the image, and including a plurality of detection targets is acquired, cutting out the specified area from the image and causing to display the area, and causing to display the position information and the score regarding the predetermined number of the detection targets included in the area.
13. The display assistance method according to any one of 10. to 12., further including,
   by the one or more computers,
   acquiring, as switching information on the detection target, an input from an operator.
14. The display assistance method according to any one of 10. to 13., wherein
   the switching information includes direction information indicating a switching direction of the detection target serving as the detection result display target,
   the display assistance method further including,
   by the one or more computers,
      causing to display the position information and the score by setting the detection target located in the direction indicated by the input direction information, as the next detection result display target from among the detection target being the current detection result display target.
15. The display assistance method according to any one of 10. to 14., further including,
   by the one more computers:
   causing to display a detection result of a plurality of the detection targets in a list;
   acquiring selection information indicating the detection target selected from the list display; and
   causing to display a search result of the detection target indicated by the selection information in association with the image.
16. The display assistance method according to 15., further including,
   by the one or more computers,
      causing to display the detection result in a batch manner for each attribute of the detection result.
17. The display assistance method according to any one of 10. to 16., wherein
   the score is a score which is generated by a learning model.
18. The display assistance method according to any one of 10. to 17., further including,
   by the one or more computers:
   acquiring information indicating an instruction to select the detection target; and
   causing a storage unit to store a detection result of the selected detection target.
19. A program for causing a computer to execute:
   a procedure of acquiring a detection result of an image including a plurality of detection targets, and in which detection processing of the detection target is performed;
   a procedure of causing to display the acquired detection result of the image;
   a procedure of acquiring information indicating an instruction to the detection result;
   a procedure of setting a predetermined number of the detection targets, as a detection result display target, and causing to display position information indicating a position of the detection target within the image, and a score indicating certainty of the detection target in association with the image; and,
   when switching information indicating an instruction to switch the detection target serving as the detection result display target is acquired in the acquiring procedure, a procedure of switching the detection result display target to another of the detection target within the image, and causing to display the position information and the score related to the detection target after the switching.
20. The program according to 19., wherein
   the position information is a rectangle surrounding the detection target in the image, and,
   in the displaying procedure, the score is caused to be displayed outside of the rectangle.
21. The program according to 19. or 20., wherein,
   when area specification information indicating an instruction to specify an area being a part within the image, and including a plurality of detection targets is acquired in the procedure of acquiring information indicating the instruction,
   in the displaying procedure,
      the specified area is cropped from the image and is caused to be displayed, and
      the position information and the score are caused to be displayed regarding the predetermined number of the detection targets included in the area.
22. The program according to any one of 19. to 21., wherein,
   in the procedure of acquiring information indicating the instruction, an input from an operator is acquired as switching information on the detection target.
23. The program according to any one of 19. to 22., wherein
   the switching information includes direction information indicating a switching direction of the detection target serving as the detection result display target, and,
   in the displaying procedure, the position information and the score are caused to be displayed by setting the detection target located in the direction indicated by the input direction information, as the next detection result display target from among the detection target being the current detection result display target.
24. The program according to any one of 19. to 23., wherein,
   in the displaying procedure, a detection result of a plurality of the detection targets is displayed in a list,
   in the procedure of acquiring information indicating the instruction, selection information indicating the detection target selected from the list display is acquired, and,
   in the displaying procedure, a search result of the detection target indicated by the selection information is caused to be displayed in association with the image.
25. The program according to 24., wherein,
   in the displaying procedure,
      the detection result is caused to be displayed in a batch manner for each attribute of the detection result.
26. The program according to any one of 19. to 25., wherein
   the score is a score which is generated by a learning model.
27. The program according to any one of 19. to 26., wherein,
   in the procedure of acquiring information indicating the instruction, information indicating an instruction to select the detection target is acquired,
   the program further causing a computer to execute
   a procedure of causing a storage unit to store a detection result of the selected detection target.
28. A computer-readable storage medium storing a program for causing a computer to execute:
   a procedure of acquiring a detection result of an image including a plurality of detection targets, and in which detection processing of the detection target is performed;
   a procedure of causing to display the acquired detection result of the image;
   a procedure of acquiring information indicating an instruction to the detection result;
   a procedure of setting a predetermined number of the detection targets, as a detection result display target, and causing to display position information indicating a position of the detection target within the image, and a score indicating certainty of the detection target in association with the image; and,
   when switching information indicating an instruction to switch the detection target serving as the detection result display target is acquired in the acquiring procedure, a procedure of switching the detection result display target to another of the detection target within the image, and causing to display the position information and the score related to the detection target after the switching.
29. The computer-readable storage medium storing a program according to 28., wherein
   the position information is a rectangle surrounding the detection target in the image, and,
   in the displaying procedure, the score is caused to be displayed outside of the rectangle.
30. The computer-readable storage medium storing a program according to 28. or 29., wherein,
   when area specification information indicating an instruction to specify an area being a part within the image, and including a plurality of detection targets is acquired in the procedure of acquiring information indicating the instruction,
   in the displaying procedure,
      the specified area is cropped from the image and is caused to be displayed, and
      the position information and the score are caused to be displayed regarding the predetermined number of the detection targets included in the area.
31. The computer-readable storage medium storing a program according to any one of 28. to 30., wherein,
   in the procedure of acquiring information indicating the instruction, an input from an operator is acquired as switching information on the detection target.
32. The computer-readable storage medium storing a program according to any one of 28. to 31., wherein
   the switching information includes direction information indicating a switching direction of the detection target serving as the detection result display target, and,
   in the displaying procedure, the position information and the score are caused to be displayed by setting the detection target located in the direction indicated by the input direction information, as the next detection result display target from among the detection target being the current detection result display target.
33. The computer-readable storage medium storing a program according to any one of 28. to 32., wherein,
   in the displaying procedure, a detection result of a plurality of the detection targets is displayed in a list,
   in the procedure of acquiring information indicating the instruction, selection information indicating the detection target selected from the list display is acquired, and,
   in the displaying procedure, a search result of the detection target indicated by the selection information is caused to be displayed in association with the image.
34. The computer-readable storage medium storing a program according to 33., wherein,
   in the displaying procedure,
      the detection result is caused to be displayed in a batch manner for each attribute of the detection result.
35. The computer-readable storage medium storing a program according to any one of 28. to 34., wherein
   the score is a score which is generated by a learning model.
36. The computer-readable storage medium storing a program according to any one of 28. to 35., wherein,
   in the procedure of acquiring information indicating the instruction, information indicating an instruction to select the detection target is acquired,
   the storage medium further causing a computer to execute
   a procedure of causing a storage unit to store a detection result of the selected detection target.

### REFERENCE SIGNS LIST

1 Image analysis system
2 Communication network
20 Image analysis apparatus
30 Learning model
40 Detection result storage unit
100 Display assistance apparatus
102 Detection result acquisition unit
104 Display processing unit
106 Instruction acquisition unit
108 Storage processing unit
110 Display apparatus
120 Operation unit
130 Evaluation result storage unit
200 Image
210 Rectangular frame
220 Label
240 Area
300 Image
310 Rectangular frame
320 Emphasis display
322 Label
330 Search result list
332 Record
334 Checkbox
336 Identification information display unit
338 Scroll bar
340 Record
1000 Computer
1010 Bus
1020 Processor
1030 Memory
1040 Storage device
1050 Input/output interface
1060 Network interface

What is claimed is:

1. A display assistance apparatus comprising:
at least one memory store instructions; and
at least one processor configured to execute the instructions to:
acquire a detection result of an image including a plurality of detection targets, and in which detection processing of the detection target is performed;
cause to display the acquired detection result of the image; and
acquire information indicating an instruction to the detection result, wherein
set a predetermined number of the detection targets, as a detection result display target, and causes to display position information indicating a position of the detection target within the image, and a score indicating certainty of the detection target in association with the image, and,
when acquiring switching information indicating an instruction to switch the detection target serving as the detection result display target, switch the detection result display target to another of the detection target within the image, and causes to display the position information and the score related to the detection target after the switching.

2. The display assistance apparatus according to claim 1, wherein
the position information is a rectangle surrounding the detection target in the image, and
the at least one processor is further configured to execute the instructions to cause the display processing unit causes to display the score outside of the rectangle.

3. The display assistance apparatus according to claim 1, wherein,
the at least one processor is further configured to execute the instructions to
when acquiring area specification information indicating an instruction to specify an area being a part within the image, and including a plurality of detection targets, crop the specified area from the image and causes to display the area; and
cause to display the position information and the score regarding the predetermined number of the detection targets included in the area.

4. The display assistance apparatus according to claim 1, wherein
the at least one processor is further configured to execute the instructions to
acquire, as switching information on the detection target, an input from an operator.

5. The display assistance apparatus according to claim 1, wherein
the switching information includes direction information indicating a switching direction of the detection target serving as the detection result display target, and
the at least one processor is further configured to execute the instructions to
cause to display the position information and the score by setting the detection target located in the direction indicated by the input direction information, as the next detection result display target from among the detection target being the current detection result display target.

6. The display assistance apparatus according to claim 1, wherein
the at least one processor is further configured to execute the instructions to
cause to display a detection result of a plurality of the detection targets in a list;
acquire selection information indicating the detection target selected from the list display; and
cause to display a search result of the detection target indicated by the selection information in association with the image.

7. The display assistance apparatus according to claim 6, wherein
the at least one processor is further configured to execute the instructions to
cause to display the detection result in a batch manner for each attribute of the detection result.

8. The display assistance apparatus according to claim 1, wherein
the score is a score which is generated by a learning model.

9. The display assistance apparatus according to claim 1, wherein
the at least one processor is further configured to execute the instructions to
acquire information indicating an instruction to select the detection target;
cause a storage unit to store a detection result of the selected detection target.

10. A display assistance method comprising,
by one or more computers:
acquiring a detection result of an image including a plurality of detection targets, and in which detection processing of the detection target is performed;
causing to display the acquired detection result of the image;
setting a predetermined number of the detection targets, as a detection result display target, and causing to display position information indicating a position of the detection target within the image, and a score indicating certainty of the detection target in association with the image; and,
when switching information indicating an instruction to switch the detection target serving as the detection result display target is acquired, switching the detection result display target to another of the detection target within the image, and causing to display the position information and the score related to the detection target after the switching.

11. A non-transitory computer-readable medium storing a program for causing a computer to execute:
acquiring a detection result of an image including a plurality of detection targets, and in which detection processing of the detection target is performed;
causing to display the acquired detection result of the image;
acquiring information indicating an instruction to the detection result;
setting a predetermined number of the detection targets, as a detection result display target, and causing to display position information indicating a position of the detection target within the image, and a score indicating certainty of the detection target in association with the image; and,
when switching information indicating an instruction to switch the detection target serving as the detection result display target is acquired in the acquiring procedure, switching the detection result display target to another of the detection target within the image, and causing to display the position information and the score related to the detection target after the switching.

12. The display assistance method according to claim 10, wherein
the position information is a rectangle surrounding the detection target in the image, and
the display assistance method further comprises, by the one or more computers,
causing to display the score outside of the rectangle.

13. The display assistance method according to claim 10, further comprising,
by the one or more computers,
when acquiring area specification information indicating an instruction to specify an area being a part within the image, and including a plurality of detection targets, cropping the specified area from the image and causes to display the area; and
causing to display the position information and the score regarding the predetermined number of the detection targets included in the area.

14. The display assistance method according to claim 10, further comprising,
by the one or more computers,
acquiring, as switching information on the detection target, an input from an operator.

15. The display assistance method according to claim 10, wherein
the switching information includes direction information indicating a switching direction of the detection target serving as the detection result display target, and
the display assistance method further comprises, by the one or more computers,
causing to display the position information and the score by setting the detection target located in the direction indicated by the input direction information, as the next detection result display target from among the detection target being the current detection result display target.

16. The non-transitory computer-readable medium according to claim 11, wherein
the position information is a rectangle surrounding the detection target in the image, and
the program causes the computer to execute
causing to display the score outside of the rectangle.

17. The non-transitory computer-readable medium according to claim 11, wherein the program causes the computer to execute:
when acquiring area specification information indicating an instruction to specify an area being a part within the image, and including a plurality of detection targets, cropping the specified area from the image and causes to display the area; and
causing to display the position information and the score regarding the predetermined number of the detection targets included in the area.

18. The non-transitory computer-readable medium according to claim 11, wherein the program causes the computer to execute:
acquiring, as switching information on the detection target, an input from an operator.

19. The non-transitory computer-readable medium according to claim 11, wherein
the switching information includes direction information indicating a switching direction of the detection target serving as the detection result display target, and
the program causes the computer to execute
causing to display the position information and the score by setting the detection target located in the direction indicated by the input direction information, as the next detection result display target from among the detection target being the current detection result display target.
